(19) United States
(12) Patent Application Publication
(10) Pub. No.: US 2004/0101649 A1
(43) Pub. Date: May 27, 2004

(54) Pre-fabricated laminated wood element

(76) Inventor: Erwin Thoma, St Johann/Pongau (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/474,245

(22) PCT Filed: Apr. 25, 2002
(86) PCT No.: PCT/AT02/00128

(30) Foreign Application Priority Data
Apr. 26, 2001 (AT) A 678/01

(51) Int. Cl. B32B 3/10

(52) U.S. Cl. 428/54

(57) ABSTRACT

The invention relates to a pre-fabricated laminated wood element comprising at least three layers (2a, 2b, 2c, 2d, 2e, 2f) of adjacent plank or stanchion-type wooden elements (3a, 3b, 3c, 3d, 3e, 3f) that are connected to one another. Said connection is achieved by dowels (4), which penetrate the layers (2a, 2b, 2c, 2d, 2e, 2f) of wooden elements (3a, 3b, 3c, 3d, 3e, 3f), whereby the wooden elements (3a, 3b, 3c, 3d, 3e, 3f) of at least two neighbouring layers (2a, 2b, 2c, 2d, 2e, 2f) run in a different direction. The wooden elements (3a, 3b, 3c, 3d, 3e, 3f) on the interior surfaces of the laminated wood element are at least partially profiled, which permits improved thermal insulation.

The invention relates to a prefabricated laminated wood element according to the preamble of claim 1.

It is known to compose wood elements of several layers of boards. Individual boards may be provided with a profiling in order to reduce the weight, create hollow spaces for installing items or improve heat insulation. Such composite materials are usually fastened by gluing, which on the one hand leads to a deterioration in the heat insulation properties when the glue seeps into the grooves of the profiling or even fills the same, and on the other hand such composite materials pose problems in recycling.

From WO 00/03850 A of the applicant a prefabricated laminated wood element is known which consists of several layers of wood which are mutually connected by way of dowels. The advantage of such a laminated wood element is that walls can be thus produced which are made of biologically produced material without any chemical bonding agents, nails or the like. These walls are characterized by favorable static properties and favorable heat insulation. Furthermore, such laminated wood elements have a very high resistance to fires and an outstanding screening against high-frequency electric fields.

Furthermore, from DE 297 21 848 U a wooden wall is known which is composed of several layers of boards which are connected with each other by means of nailing. In order to reduce the production costs the boards are provided in the interior so as to be rough from sawing.

It is the object of the present invention to provide a wall element which is completely made up of biological material and that allows a further improvement in heat insulation.

This object is achieved in accordance with the invention by the arrangement according to claim 1.

It has been seen that an additional improvement in the heat insulation properties can be achieved by the arrangement in accordance with the invention without any impairment to the strength. Air chambers are created in the interior of the laminated wood element which increase the thermal resistance, i.e. they decrease the thermal conductivity. An additional advantage in the configuration in accordance with the invention is that as a result of the dowels it is possible to produce relatively high pressing forces between the individual layers and to hold the same permanently, so that the strength of the laminated wood element is not impaired by the lower bearing surfaces between the individual boards which is caused by the profiling.

The profiling can be provided with a sufficiently small dimensioning only by using dowels instead of other joining means, so that no convection flows can form in the interior which could be disadvantageous for the insulation value of the laminated wood element. This is possible because one need not fear that a gluing medium will seal the grooves.

The additional processing of the individual wood elements by planing can lead to the additional advantage that the maximum positive tolerance in the thickness region can be delimited very precisely. When using wood elements which have not been finished after the sawing it may occur that several wood elements with positive tolerance deviation lie above one another at individual places of the wall element, thus leading to a locally impermissible overall thickness.

The thermal conductivity of a laminated wood element can be improved from λ=0.15 W/mK to 0.11 W/mK for a typical laminated wood element of conventional design to λ=0.09 W/mK to 0.08 W/mK for the laminated wood element in accordance with the invention. This improvement is not only relevant for saving energy, but also improves the fire protection properties. A fire resistance class of F150 to F180 can be achieved already with the known laminated wood elements. The arrangement in accordance with the invention allows achieving a very low heat transmission in addition to these outstanding values, which is very important for obstructing the spreading of fires.

An especially favorable embodiment of the invention is given that the profiling is configured as an arrangement of adjacently situated grooves extending in the longitudinal direction. The grooves are produced for example by planing the individual wood elements with respectively profiled planing blades. As an alternative, the profiling can also be produced by transversal cutting, which is generally more laborious. In certain applications it is advantageous when the face surfaces of the laminated wood element are provided with closed arrangement. This is achieved when the edge zone of the laminated wood element is free from grooves, i.e. the grooves do not continue up to the edge, but trail out before the edge.

An especially favorable heat insulation can be achieved in such a way that at least two adjacent layers of wood are provided whose adjacent surfaces comprise grooves which are arranged at an angle with respect to each other. In this way a raster-like system of hollow spaces is created, with the individual wood elements resting only on the cross-over points of the webs between the grooves. It is especially advantageous in this connection when webs are provided between the grooves whose width is smaller than that of the grooves, with the width of the webs preferably being between 20% and 80% of the width of the grooves. The contact surfaces between the wood elements are thus minimized.

Cable ducts or conduits can be taken into account advantageously already during the configuration of the wall element when at least one layer comprises a groove-like recess, with the recess preferably being formed by cutting or excavating adjacent wood elements. In this way the installation work can be simplified after completing a building.

An especially advantageous joint can be achieved in such a way that the bonding between dowels and wood elements occurs by frictional connection due to an increase in the volume by exchange of humidity between the wood elements of the layers and the dowels.

Within the terms of construction biology and ability to recycle the materials it is especially desirable when the laminated wood element is composed of one material and only consists of wood. Disturbing influences of other materials can thus be excluded.

Especially advantageous static properties can be achieved when the laminated wood element comprises at least two layers which are perpendicular with respect to each other and at least one layer which is arranged thereto in a position arranged at an acute angle. In such a laminated wood element the layers which are perpendicular in the installed state will absorb the majority of the static loads acting upon the wall element. The horizontal wood elements are used mainly for joining the perpendicular wood elements and at least one layer arranged in an inclined way is used for avoiding a possible deformation in the form of a parallelogram within the plane of the wall.

The invention is now explained in closer detail by reference to embodiments shown in the enclosed drawings, wherein:

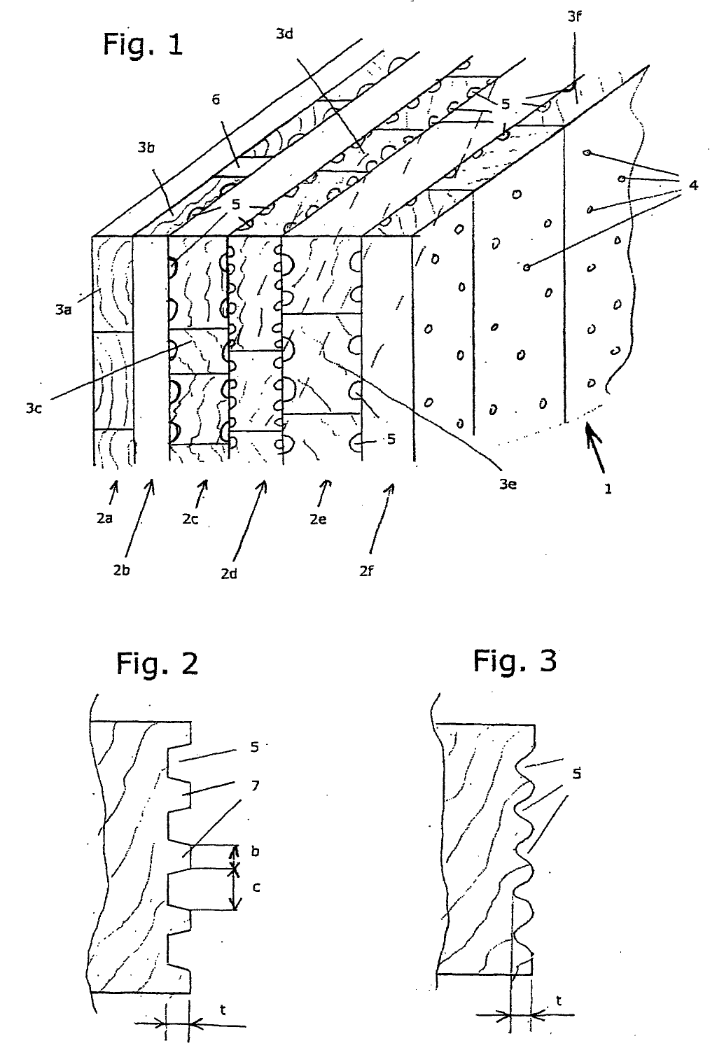

FIG. 1 shows a part of a wall element in accordance with the invention, and

FIGS. 2 and 3 show partial sectional views through wood elements which make up such a wall element.

The laminated wood element 1 of FIG. 1 consists of six layers 2a, 2b, 2c, 2d, 2e and 2f of wood elements 3a, 3b, 3c, 3d, 3e and 3f. The layers 2a, 2c and 2e are arranged in the used state in such a way that the longitudinal axes of the wood elements 3a, 3c and 3e are horizontal, whereas the layers 2b and 2f are arranged perpendicularly. The individual layers 2a, 2b, 2d, 2e and 2f are held together by dowels 4, as is described in WO 00/03850 A. The wood elements 3b, 3c, 3d, 3e and 3f are profiled by the grooves 5 which extend in the horizontal direction, with the wood elements 3a and 3f being provided with a smooth arrangement on the outwardly facing surface.

Recesses 6 are provided between the individual wood elements 3b of layer 2b which are used for receiving cables or leads.

Two possible embodiments are shown in FIGS. 2 and 3 which are designated here generally with reference numeral 3. The grooves 5 in the embodiment of FIG. 2 are provided with a substantially trapezoid arrangement and have a depth t of 3 mm and a width c of 3 mm. The width b of webs 7 between the grooves 5 is 2 mm. The depth t can vary between 0.5 and 8 mm and more depending on the application. The widths b and c can be up to 40 mm and in special cases up to 100 mm.

The embodiment of FIG. 3 corresponds substantially to that of FIG. 2. The grooves 5 are arranged in the form of waves however.

The present invention allows substantially increasing the thermal resistance of a wall element while maintaining virtually the same strength.

1. A prefabricated laminated wood element comprising at least three mutually connected layers (2a, 2b, 2c, 2d, 2e, 2f) of plank- or stanchion-type wood elements (3a, 3b, 3c, 3d, 3e, 3f) which are arranged directly adjacent to each other, with the wood elements (3a, 3b, 3c, 3d, 3e, 3f) of at least two adjacent layers (2a, 2b, 2c, 2d, 2e, 2f) having different directions, with the wood elements (3a, 3b, 3c, 3d, 3e, 3f) having a profiling at least partially on the surfaces situated in the interior of the laminated wood element, characterized in that the connection of the wood elements (3a, 3b, 3c, 3d, 3e, 3f) occurs by dowels (4) which penetrate the layers (2a, 2b, 2c, 2d, 2e, 2f) of wood elements (3a, 3b, 3c, 3d, 3e, 3f).

2. A laminated wood element according to claim 1, characterized in that the profiling is configured as an arrangement of adjacently situated grooves (5) extending in the longitudinal direction.

3. A laminated wood element according to one of the claims 1 or 2, characterized in that at least two adjacent layers (2a, 2b, 2c, 2d, 2e, 2f) of wood elements (3a, 3b, 3c, 3d, 3e, 3f) are provide whose contacting surfaces comprise grooves which are arranged at an angle with respect to each other.

4. A laminated wood element according to one of the claims 2 or 3, characterized in that webs (7) are provided between the grooves (5) whose width (b) is smaller than that of the grooves (5), with the width (b) of the webs (7) preferably being between 20% and 80% of the width (c) of the grooves (5).

5. A laminated wood element according to one of the claims 2 to 4, characterized in that the edge region of the laminated wood element is free from grooves (5).

6. A laminated wood element according to one of the claims 1 to 4, characterized in that at least two adjacent layers (2a, 2b, 2c, 2d, 2e, 2f) of wood elements (3a, 3b, 3c, 3d, 3e, 3f) are provided whose longitudinal axes are arranged at an angle with respect to each other and whose contacting surfaces are both profiled.

7. A laminated wood element according to one of the claims 1 to 5, characterized in that at least one layer comprises a groove-like recess, with the recess being preferably formed by cutting or excavating adjacent wood elements.

8. A laminated wood element according to one of the claims 1 to 6, characterized in that the dowels (4) are arranged in a raster-like manner.

9. A laminated wood element according to one of the claims 1 to 7, characterized in that the connection between the dowels (4) and the wood elements (3a, 3b, 3c, 3d, 3e, 3f) occurs substantially by frictional connection due to increase in volume by humidity exchange between the wood elements (3a, 3b, 3c, 3d, 3e, 3f) of the layers (2a, 2b, 2c, 2d, 2e, 2f) and the dowels (4).

10. A laminated wood element according to one of the claims 1 to 8, characterized in that the laminated wood element (1) is made of one single material and only consists of wood.

11. A laminated wood element according to one of the claims 1 to 9, characterized in that the laminated wood element (1) comprises at least two layers (2a, 2b, 2c, 2d, 2e, 2f) which are mutually perpendicular and at least one layer (2d ) which is arranged relative to the same at an acute angle.
